(19) United States
(12) Patent Application Publication
(10) Pub. No.: US 2025/0110008 A1
(43) Pub. Date: Apr. 3, 2025

(54) RE-USING DISTRIBUTED FIBER OPTIC SENSING TO DETECT LEAKS AT MULTIPLE LOCATIONS

(71) Applicant: Chevron U.S.A. Inc., San Ramon, CA (US)

(72) Inventors: Nikolaos Ioannis Salmatanis, Cypress, TX (US); Omar Visairo, Carlsbad, NM (US)

(21) Appl. No.: 18/478,617

(22) Filed: Sep. 29, 2023

(51) Int. Cl. G01M 3/14

(52) U.S. Cl. CPC G01M 3/142

(57) ABSTRACT

An above ground pipe is installed at a location to transport fluid for one or more operations. A fiber optic cable is laid on the above ground pipe and temporarily attached to the above ground pipe. The fiber optic cable is laid on the above ground pipe with a sinusoidal curvature to increase contact between the fiber optic cable and the above ground pipe. Leaks along the above ground pipe are detected using measurements from the fiber optic cable. The fiber optic cable is removed from the above ground pipe for re-use at a different location.

### TECHNICAL FIELD

The present disclosure relates generally to the field of temporarily attaching a fiber optic cable to an above ground pipe to detect fluid leaks along the above ground pipe.

### BACKGROUND

Pipes may be installed above ground at a location to transport fluid. For example, above ground pipes may be installed at a location to transport fluid for hydraulic fracturing of a well. Leaks along the above ground pipes may cause loss of fluid. Permanent installation of leak detection equipment along the above ground pipes may be time consuming and costly.

### SUMMARY

This disclosure relates to re-using distributed fiber optic sensing to detect leaks at multiple locations. An above ground pipe may be installed at a location. A fiber optic cable may be laid on and temporarily attached to the above ground pipe. The fiber optic cable may be removable from the above ground pipe for re-use at a different location. Fluid leaks along the above ground pipe may be detected based on measurement using the fiber optical cable laid on and temporarily attached to the above ground pipe and/or other information.

A system for re-using distributed fiber optic sensing to detect leaks at multiple locations may include one or more above ground pipes, one or more fiber optic cables, one or more processors, and/or other components. The above ground pipe(s) may include one or more surface laid pipes, one or more lay-flat pipes, one or more steel pipes, one or more PVC pipes, one or more synthetic pipes, one or more polyethylene pipes, and/or other types of pipes. The above ground pipe(s) may be installed at a location.

In some implementations, the above ground pipe(s) may be installed at the location for hydraulic fracturing of one or more wells. The above ground pipe(s) may operate as a flowline to transport fluid for the hydraulic fracturing of the well(s).

One or more fiber optic cables laid on the above ground pipe(s). In some implementations, the fiber optic cable(s) may be laid on the above ground pipe(s) with a sinusoidal curvature. The sinusoidal curvature of the fiber optic cable may increase contact between the fiber optic cable(s) and the above ground pipe(s). The sinusoidal curvature of the fiber optic cable(s) may position the fiber optic cable(s) between a five o'clock position and a seven o'clock position of the above ground pipe(s). The sinusoidal curvature of the fiber optic cable(s) may be stretched and/or squeezed along the above ground pipe(s).

The fiber optic cable(s) may be temporarily attached to the above ground pipe(s). The fiber optic cable(s) may be removable from the above ground pipe(s) for re-use at a different location. The fiber optic cable(s) may be removed from the above ground pipe(s) for re-use on same or different above ground pipe(s) at the different location.

The processor(s) may be configured by machine-readable instructions. Executing the machine-readable instructions may cause the processor(s) to facilitate detecting fluid leaks. The processor(s) may be configured by machine readable-instructions to detect fluid leaks along the above ground pipe(s). The fluid leaks along the above ground pipe(s) may be detected based on measurement using the fiber optic cable(s) laid on and temporarily attached to the above ground pipe(s) and/or other information.

In some implementations, the processor(s) may be further configured by the machine readable-instructions to facilitate one or more operations for the above ground pipe(s) based on detection of fluid leaks along the above ground pipe(s) and/or other information.

In some implementations, the processor(s) may be further configured by the machine readable-instructions to locate pinch-points along the above ground pipe(s). The pinch-points along the above ground pipe(s) may be located based on the measurement using the fiber optic cable(s) laid on and temporarily attached to the above ground pipe(s) and/or other information. The processor(s) may be further configured by the machine readable-instructions to identify one or more kinks in the above ground pipe(s) at the pinch-points. The processor(s) may be further configured by the machine readable-instructions to facilitate fixing of the kink(s) in the above ground pipe(s).

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example scenario of re-using distributed fiber optic sensing to detect leaks at multiple locations.

FIG. 2 illustrates an example method for re-using distributed fiber optic sensing to detect leaks at multiple locations.

FIG. 3 illustrates examples of a fiber optic cable laid on pipes.

FIG. 4 illustrates an example positions of a fiber optic cable on a pipe.

FIG. 5 illustrates example pinch points along a pipe.

### DETAILED DESCRIPTION

The present disclosure relates to re-using distributed fiber optic sensing to detect leaks at multiple locations. An above ground pipe is installed at a location to transport fluid for one or more operations. A fiber optic cable is laid on the above ground pipe and temporarily attached to the above ground pipe. The fiber optic cable is laid on the above ground pipe with a sinusoidal curvature to increase contact between the fiber optic cable and the above ground pipe. Leaks along the above ground pipe are detected using measurements from the fiber optic cable. The fiber optic cable is removed from the above ground pipe for re-use at a different location.

A pipe may refer to a tube used to convey materials. A pipe may be composed of one or more materials. Examples of pipes that may be installed at a location may include one or more lay-flat pipes, one or more steel pipes, one or more polyvinyl chloride (PVC) pipes, one or more synthetic pipes, one or more polyethylene pipes, and/or other types of pipes. A pipe installed above the ground may be referred to as an above ground pipe.

Pipes may be used to transport (e.g., carry, convey) materials. For example, pipes may be used to transport fluid. Accurate and timely detection of leaks along the pipes is crucial to limit fluid loss. However, installation of permanent leak detection equipment along the pipes may be time consuming and costly. For example, lay-flat or surface laid pipes may be temporarily installed at a location to be used as a flowline to transport fluid for hydraulic fracturing of one or more wells. The lay-flat/surfaced laid pipes may be removed from the location after hydraulic fracturing has been completed. The time and costs required to install permanent leak detection equipment may make it impractical to use such equipment to detect leaks along the lay-flat/surface laid pipes.

The present disclosure provides for temporary attachment of fiber optic cables to pipes to detect fluid leaks along the pipes. The fiber optic cables are used as sensors to detect leaks along the pipes. For example, the fiber optic cables are used as sensors for distributed fiber optic sensing leak detection system. The fiber optic cables/distributed fiber optic sensing leak detection system may be tuned to the types of pipes, the sizes of the pipes, the configurations of the pipes, the types of fluid transported by the pipes, the types of environment in which the pipes are installed, and/or other factors. The fiber optic cables are removable from the pipes for re-use at another location.

For example, the fiber optic cables may be temporarily attached to surface-laid/lay-flat pipes that transport fluid for hydraulic fracturing of well(s). The fiber optic cables may be used as sensors to detect leaks along the surface laid/lay-flat pipes. The fiber optic cables may be used as sensors to provide a real-time leak monitoring for the surface laid/lay-flat pipes while the pipes are in use. Leak detection via the fiber optic cables may be used to facilitate real-time control operations/options for the surface laid/lay-flat pipes and/or equipment connected to the pipes. Once the hydraulic fracturing has been completed, the fiber optic cables may be removed from the surface laid/lay-flat pipes and re-used at another location (e.g., for another hydraulic fracturing operation, for a different operation).

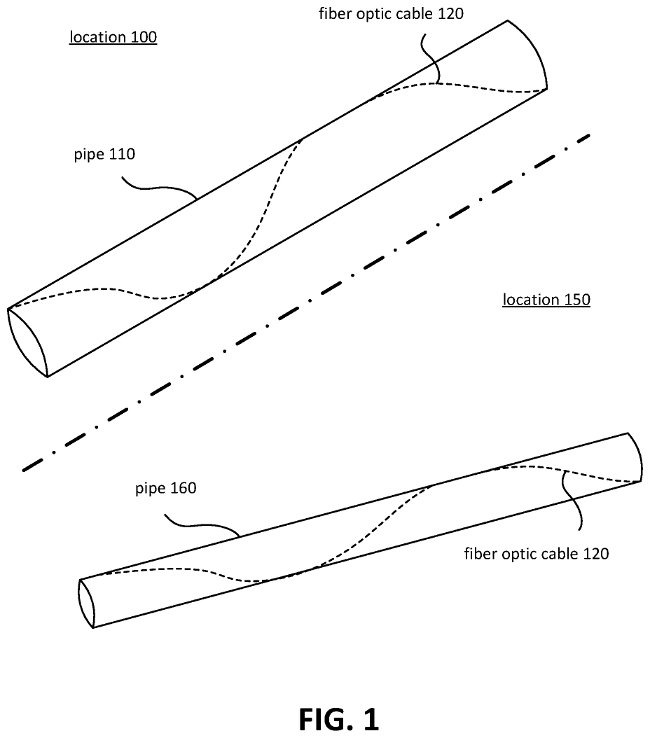

The methods and systems of the present disclosure may be implemented in various scenarios, such as shown in FIG. 1. FIG. 1 shows two different locations: location 100 and location 150. A pipe 110 may be installed at the location 100 and a pipe 160 may be installed at the location 150. The pipe 110 may be same as or different from the pipe 160. For example, the pipe 110 and the pipe 160 may be the same type of pipe or different types of pipe. The pipe 110 and the pipe 160 may be installed in the same configuration or in different configurations. Installing a pipe may include fixing, laying, placing, positioning, setting up, and/or otherwise installing the pipe. The pipe 110 and the pipe 160 may be installed above ground. The pipe 110 and the pipe 160 may be laid on the surface or above the surface of the Earth. The pipe 110 and the pipe 160 may include above ground pipes, such as surface-laid pipes. The pipes may be installed at the locations 100, 150 for same or different operations, such as to operate as a flowline to transport fluid for hydraulic fracturing of well(s) and/or to support/facilitate other operations.

One or more fiber optic cables may be laid on the pipes. For example, fiber optic cable(s) may be laid on above-ground pipe(s). Laying a fiber optic cable on a pipe may include placing, putting down, setting, and/or otherwise laying the fiber optic cable on the pipe. A fiber optic cable may be laid on a pipe to contact the pipe (with the surface of the pipe). A fiber optic cable may refer to an assembly containing one or more optical fibers used to carry light. The optical fiber(s) may be coated with layers (e.g., plastic layers). The optical fiber(s) may be contained in a protective tube. A fiber optic cable may be reinforced with one or more materials to enable the fiber optic cable to be unwound/unspooled and wound/spooled without damage to the optical fiber(s). A fiber optic cable may be coated to enhance acoustic sensitivity of the optical fiber(s).

One or more fiber optic cables may be laid on a pipe (e.g., above ground pipe) with a curvature. For example, referring to FIG. 1, a fiber optic cable 120 may be laid on the pipe 110 with a sinusoidal curvature. Use of other curvature (e.g., zigzag, sawtooth, triangular) in laying fiber optic cables on pipes is constipated. The curvature of the fiber optic cable(s) may increase contact between the fiber optic cable(s) and the pipe(s). For example, the sinusoidal curvature of the fiber optic cable 120 may increase contact between the fiber optic cable 120 and the pipe. The curvature of the fiber optic cable(s) may increase the length along the fiber optic cable(s) that contacts the pipe(s). The curvature of the fiber optic cable(s) may reduce sagging of the fiber optic cable(s) along the pipe(s). The curvature of the fiber optic cable(s) may ensure contact between the fiber optic cable(s) and the pipe(s) when the form of the pipe(s) changes. For example, the curvature of the fiber optic cable(s) may ensure that there is sufficient contact between the fiber optic cable(s) and a lay-flat pipe when the lay-flat pipe is inflated during usage.

The curvature of a fiber optic cable may be changed (stretched and/or squeezed) along a pipe. Stretching the curvature of a fiber optic cable may include extending the curvature to widen the curvature of the fiber optic cable along the pipe. Squeezing the curvature of a fiber optic cable may include compressing the curvature to shorten the curvature of the fiber optic cable along the pipe. The curvature of a fiber optic cable may be changed based configuration (e.g., shape, size) of the pipe, equipment located along the pipe, and/or other factors. For example, the curvature of a fiber optic cable may be stretched for a straight pipe without any equipment. The curvature of a fiber optic cable may be squeezed for curvature (e.g., bend) in the pipe and/or based on presence of equipment (e.g., joints, collars, valves, couplers, pumps) along the pipe.

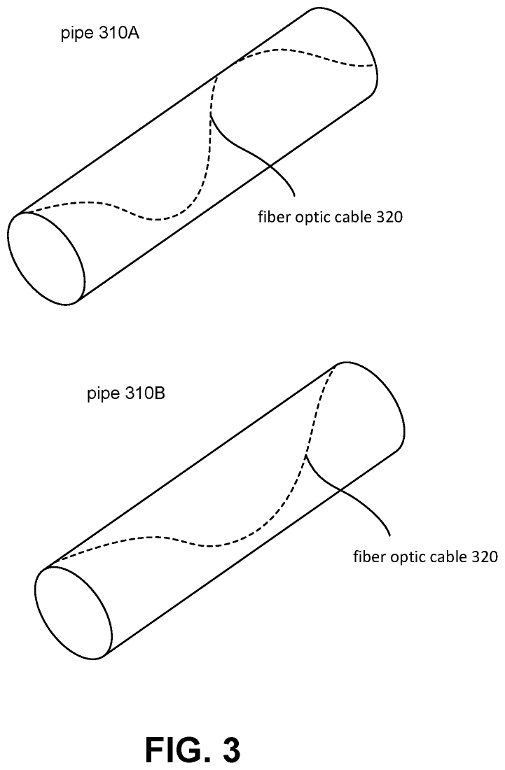

FIG. 3 illustrates examples of a fiber optic cable 320 laid on pipes 310A, 310B. In FIG. 3, the sinusoidal curvature of the fiber optic cable 320 may be stretched and/or squeezed along the pipes 310A, 310B. The sinusoidal curvature of the fiber optic cable 320 may be squeezed along the pipe 310A and the sinusoidal curvature of the fiber optic cable 320 may be stretched along the pipe 310B.

The curvature of a fiber optic cable may position the fiber optic cable between different positions around the pipe. The curvature of a fiber optic cable may position the fiber optic cable at different cross-sectional points as the fiber optic cable runs along the pipe. The curvature of a fiber optic cable may cause the fiber optic cable to loop back and forth between different cross-sectional positions as the fiber optic cable runs along the pipe.

For example, referring to FIG. 3, the sinusoidal curvature of the fiber optic cable 320 may position the fiber optic cable 320 between different positions around the pipes 310A, 310B as the fiber optic cable 320 runs along the pipes 310A, 310B. The cross-sectional points at which the fiber optic cable 320 contacts the pipes 310A, 310B may change as the fiber optic cable 320 runs along the pipes 310, 310B.

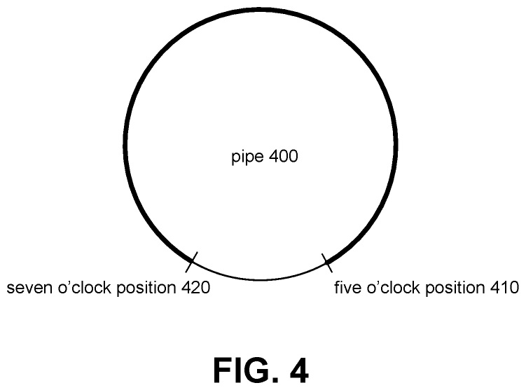

FIG. 4 illustrates an example positions of a fiber optic cable on a pipe 400. FIG. 4 may show a cross-sectional view of the pipe 400. The curvature (e.g., sinusoidal curvature) of the fiber optic cable on the pipe 400 may position the fiber optic cable between a five o'clock position 410 and a seven o'clock position 420 of the pipe 400. As the fiber optic cable runs along the pipe 400, the curvature of the fiber optic cable may cause the fiber optic cable to loop back and forth between the five o'clock position 410 and a seven o'clock position 420 of the pipe 400. The fiber optic cable may run from the five o'clock position 410, run over the top of the pipe 400 to the seven o'clock position 420 of the pipe 400, run back over the top of the pipe 400 to the five o'clock position 410, and repeat. The curvature of the fiber optic cable may position the fiber optic cable between other positions of the pipe (e.g., between one and eleven o'clock positions; between two and ten o'clock positions; between three and nine o'clock positions; between four and eight o'clock positions).

The fiber optic cable(s) may be temporarily attached to the pipe(s). For example, referring to FIG. 1, the fiber optic cable 120 may be temporarily attached to the pipe 110. Attachment of a fiber optic cable to a pipe may provide tension control for the fiber optic cable along the pipe. A fiber optic cable being temporarily attached to a pipe my include the fiber optic cable being attached to the pipe so that the fiber optic cable may be removed from the pipe. A fiber optic cable being temporarily attached to a pipe my include the fiber optic cable being attached to the pipe so that the fiber optic cable may be removed from the pipe without damage to the fiber optic cable and/or the pipe. A fiber optic cable may be temporarily attached to a pipe using magnets, adhesives (e.g., adhesive tapes), Velcro, clips (e.g., plastic/metal clips), zip ties, and/or other attachment mechanisms. A fiber optic cable may be attached at various points along the pipe. The points at which the fiber optic cable is attached to the pipe may anchor the fiber optic cable to the pipe. The points at which the fiber optic cable is attached to the pipe may determine the curvature of the fiber optic cable along the pipe.

The fiber optic cable(s) may be removable from the pipe(s) for re-use at a different location. The fiber optic cable(s) may be removed from the pipe(s) at one location for use on pipe(s) at another location. The fiber optic cable(s) may be removed from the pipe(s) for re-use on same or different pipe(s) at the different location. For example, both the pipe(s) and the fiber optic cable(s) may be moved to a new location for re-use. As another example, the fiber optic cable(s) may be moved to a new location for re-use on different pipe(s).

For example, referring to FIG. 1, the fiber optic cable 120 may be temporarily attached to the pipe 110 for leak detection along the pipe 110. The fiber optic cable 120 may be removed from the pipe 110 for re-use at the location 150. The fiber optic cable 120 may be temporarily attached to the pipe 160 for leak detection along the pipe 160. The fiber optic cable 120 may be removed from the pipe 160 for re-use at another location. The fiber optic cable 120 may be tuned based on the pipe on which it is attached (e.g., the materials of the pipe, the size of the pipe, the configuration/shape of the pipe), the fluid transported by the pipe, the environment in which the pipe is installed, and/or other factors.

Other components not shown in FIG. 1 may be deployed to detect leaks using distributed fiber optic sensing. For example, one or more interrogators, one or more processors, and/or components may be deployed to detect leaks using measurements from the fiber optic cable(s). An interrogator may refer to an optoelectronic instrument that acquires data using fiber optic cable(s). An interrogator may include a source of light and a receiver of light. The light transmitted into a fiber optic cable by an interrogator may be received by the same interrogator or a different interrogator. One or more characteristics of the light transmitted into the fiber optic cable may change. The characteristic(s) of the light transmitted into the fiber optic cable may change based on changes in temperature, pressure, strain, acoustics, and/or other characteristics of the pipe/environment around the pipe. An interrogator may use the characteristics of the received light to generate sensor data. Measurement of light characteristics using the fiber optic cable may be used to detect fluid leaks along a pipe. Measurement of light characteristics using the fiber optic cable may be used to locate fluid leaks along a pipe. Measurement of light characteristics using the fiber optic cable may indicate changes in temperature, pressure, strain, acoustics, and/or other characteristics of the pipe/environment around the pipe, and these characteristics/changes in characteristics may be used to detect leaks along the pipe.

A processor may be configured to provide information processing capabilities. As such, a processor may comprise one or more of a digital processor, an analog processor, a digital circuit designed to process information, a central processing unit, a graphics processing unit, a microcontroller, an analog circuit designed to process information, a state machine, and/or other mechanisms for electronically processing information. One or more processors may be configured by one or more machine-readable instructions to facilitate detecting fluid leaks. The processor(s) may execute one or more machine-readable instructions to facilitate detecting fluid leaks.

The processor(s) may be configured by machine readable-instructions to detect fluid leaks along one or more pipes (e.g., above ground pipe(s)). Detecting a fluid leak along a pipe may include one or more of determining, finding, identifying, locating, measuring, quantifying, and/or otherwise detecting the fluid leak along a pipe. Detecting a fluid leak along a pipe may include determining whether or not a fluid leak exists along the pipe. Detecting a fluid leak along a pipe may include determining when a fluid leak starts along the pipe. Detecting a fluid leak along a pipe may include locating where a fluid leak exists along the pipe. Determining a fluid leak along a pipe may include determining how much fluid is leaking along the pipe (e.g., leak rate, total amount of leak).

The fluid leaks along the pipe(s) may be detected based on measurement using the fiber optic cable(s) laid on and temporarily attached to the pipe(s) and/or other information. The fluid leaks along the pipe(s) may be detected based on measurement using the fiber optic cable(s) laid on and temporarily attached to the pipe(s) may be referred to as fiber optic detection of fluid leaks. Measurement using a fiber optic cable laid on and temporarily attached to a pipe may include one or more characteristics of light transmitted into the fiber optic cable. Measurement using a fiber optic cable laid on and temporarily attached to a pipe may include changes in the characteristic(s) of the light transmitted into the fiber optic cable. The characteristic(s)/changes in characteristic(s) of the light transmitted into the fiber optic cable may indicate temperature, pressure, strain, acoustics, and/or other characteristics of the pipe/environment around the pipe. The temperature, pressure, strain, acoustics, and/or other characteristics of the pipe/environment around the pipe may be used to detect fluid leaks along the pipe. The characteristic(s)/changes in characteristic(s) of the light transmitted into the fiber optic cable may indicate changes in temperature, pressure, strain, acoustics, and/or other characteristics of the pipe/environment around the pipe. The changes in temperature, pressure, strain, acoustics, and/or other characteristics of the pipe/environment around the pipe may be used to detect fluid leaks along the pipe.

In some implementations, the processor(s) may be further configured by the machine readable-instructions to facilitate one or more operations for the pipe(s) based on detection of fluid leaks along the pipe(s) and/or other information. The fiber optic detection of fluid leaks along the pipe(s) may be used to monitor the pipe(s) for leaks. For example, real time leak monitoring may be performed based on measurement using the fiber optic cable(s) laid on and temporarily attached to the pipe(s) and/or other information. Leak monitoring for a pipe may include detecting, observing, tracking, checking, maintaining surveillance over, and/or otherwise monitoring the pipe for leaks. Leak monitoring for a pipe may include generation of one or more alarms based on detection of leaks along the pipe. One or more inspection operations may be performed to confirm/assess the leak. One or more remedial operations may be performed to stop/fix the leak.

The fiber optic detection of fluid leaks along the pipe(s) may be used to control one or more operations for the pipe(s). For example, one or more operations for the pipe(s) may be performed automatically based on detection of leaks along the pipe(s). Real time controls of the operations using the pipe(s) may be performed based on the detection of leaks along the pipe(s). For example, an operation using a pipe (e.g., transport of fluid through the pipe) may be changed/stopped based on detection of one or more leaks along the pipe. For instance, a shut-down command signal may be sent to a pump for fluid transport to stop the flow of fluid through the pipe. A close command signal may be sent to an actuator to close a valve for the pipe. Control/performance of other operations based on fiber optic detection of fluid leaks is contemplated.

In some implementations, the processor(s) may be further configured by the machine readable-instructions to locate pinch-points along the pipe(s). A pinch-point along a pipe may refer to a point on a pipe at which fluid flow changes. A pinch-point along a pipe may refer to a point on a pipe at which fluid flow is restricted. Locating a pinch-point along a pipe may include determining, finding, identifying, and/or otherwise locating where the pinch-point exist along the pipe. The pinch-points along the pipe(s) may be located based on the measurement using the fiber optic cable(s) laid on and temporarily attached to the pipe(s) and/or other information. The pinch-points along the pipe(s) may be located based on one or more characteristics of light transmitted into the fiber optic cable. The pinch-points along the pipe(s) may be located based on changes in the characteristic(s) of the light transmitted into the fiber optic cable. The pinch-points along the pipe(s) may be presented on one or more electronic displays. For example, the locations of the pinch-points along the pipe(s) (e.g., geographic coordinates of the pinch-points, a map showing locations of the pinch-points along the pipe(s)) may be progesterone on the electronic display(s).

The processor(s) may be further configured by the machine readable-instructions to identify one or more kinks in the pipe(s) at the pinch-points. A kink in a pipe may refer to a sharp bend, crimp, and/or deformation in the pipe. A kink in a pipe may increase the likelihood of a leak developing in the pipe. A kink in a pipe may be a potential leak location. The processor(s) may determine which of the pinch-points along a pipe are caused by kinks in the pipe. The processor(s) may determine which of the pinch-points along a pipe are caused by kinks in the pipe by filtering out pinch-points that are known to be caused by something other than a kink. For example, pinch-points may exist at collars on the pipe. Locations of collars on the pipe may be known. Pinch-points that are located at collar locations may be filtered out as not being caused by a kink. Pinch-points that are located at known locations of particular equipment/particular pipe configuration may be filtered out as not being caused by a kink. Remaining pinch-points may be identified as kinks in the pipe.

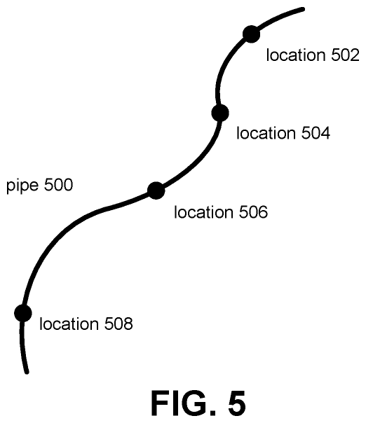

FIG. 5 illustrates example pinch points along a pipe 500. Pinch-points may be located at locations 502, 504, 506, 508 along the pipe. The locations 502, 504, 506, 508 may be labeled with known source of the pinch, such as with particular equipment/particular pipe configuration that would cause the pinch. The locations 502, 504, 506, 508 without a known source of the pinch may be identified as a kink. The locations 502, 504, 506, 508 without a known source of the pinch may be identified as potential leak locations. The locations 502, 504, 506, 508 in which a kink is identified may be identified as potential leak locations.

The processor(s) may be further configured by the machine readable-instructions to facilitate fixing of the kink(s) in the pipe(s). Facilitating fixing of the kink(s) in the pipe(s) may be include assisting, automating, carrying out, controlling, enabling, implementing, initiating, performing, planning, scheduling, setting up, and/or otherwise facilitating the fixing of the kink(s) in the pipe(s). For example, responsive to identification of a kink in a pipe, a message may be generated and sent to one or more operators of the pipe to fix the kink in the pipe. As another example, responsive to identification of a kink in a pipe, an operation to fix the kink in the pipe may be added to a maintenance schedule for the pipe. Fixing the kink(s) in the pipe(s) may reduce the likelihood of the pipe(s) developing leaks. A kink in a pipe may be fixed by straightening out the pipe at the location of the kink. A kink is a pipe may be fixed by changing how the pipe is installed/laid out to reduce the likelihood of the kink reforming at the location. Other fixing of kink(s) in the pipe(s) is contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a non-transitory, tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Any communication medium may be used to facilitate direct and/or indirect interaction between any components of the described system. One or more components of the system may communicate with each other through hard-wired communication, wireless communication, or both.

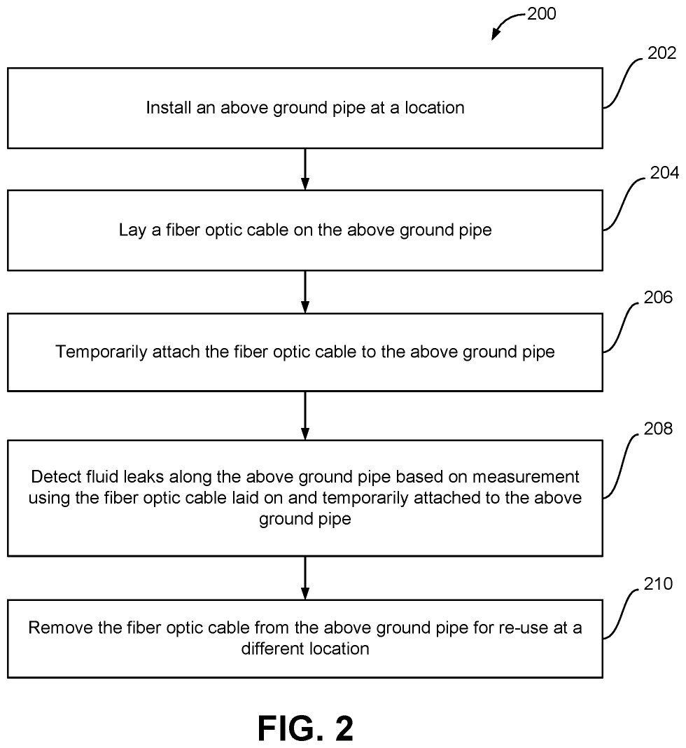

FIG. 2 illustrates method 200 for re-using distributed fiber optic sensing to detect leaks at multiple locations. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, one or more operations of the method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, an above ground pipe may be installed at a location. At operation 204, a fiber optic cable may be laid on the above ground pipe. At operation 206, the fiber optic cable may be temporarily attached to the above ground pipe. At operation 208, fluid leaks along the above ground pipe may be detected based on measurement using the fiber optic cable laid on and temporarily attached to the above ground pipe and/or other information. At operation 210, the fiber optic cable may be removed from the above ground pipe for re-use at a different location.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A method for re-using distributed fiber optic sensing to detect leaks at multiple locations, the method comprising:
installing an above ground pipe at a location;
laying a fiber optic cable on the above ground pipe;
temporarily attaching the fiber optic cable to the above ground pipe;
detecting fluid leaks along the above ground pipe based on measurement using the fiber optic cable laid on and temporarily attached to the above ground pipe; and
removing the fiber optic cable from the above ground pipe for re-use at a different location.

2. The method of claim 1, wherein:
the above ground pipe is installed at the location for hydraulic fracturing of a well; and
the above ground pipe operates as a flowline to transport fluid for the hydraulic fracturing of the well.

3. The method of claim 1, wherein the above ground pipe includes a surface-laid pipe, a lay-flat pipe, a steel pipe, a PVC pipe, a synthetic pipe, and/or a polyethylene pipe.

4. The method of claim 1, wherein the fiber optic cable is laid on the above ground pipe with a sinusoidal curvature.

5. The method of claim 4, wherein the sinusoidal curvature of the fiber optic cable increases contact between the fiber optic cable and the above ground pipe.

6. The method of claim 4, wherein the sinusoidal curvature of the fiber optic cable positions the fiber optic cable between a five o'clock position and a seven o'clock position of the above ground pipe.

7. The method of claim 4, wherein the sinusoidal curvature of the fiber optic cable is stretched and/or squeezed along the above ground pipe.

8. The method of claim 1, further comprising locating pinch-points along the above ground pipe based on the measurement using the fiber optic cable laid on and temporarily attached to the above ground pipe.

9. The method of claim 8, further comprising:
identifying one or more kinks in the above ground pipe at the pinch-points; and
fixing the one or more kinks in the above ground pipe.

10. The method of claim 1, further comprising facilitating one or more operations for the above ground pipe based on detection of fluid leaks along the above ground pipe.

11. A system for re-using distributed fiber optic sensing to detect leaks at multiple locations, the system comprising:
an above ground pipe installed at a location;
a fiber optic cable laid on and temporarily attached to the above ground pipe, wherein the fiber optic cable is removable from the above ground pipe for re-use at a different location; and
one or more physical processors configured by machine readable-instructions to detect fluid leaks along the above ground pipe based on measurement using the fiber optic cable laid on and temporarily attached to the above ground pipe.

12. The system of claim 11, wherein:
the above ground pipe is installed at the location for hydraulic fracturing of a well; and
the above ground pipe operates as a flowline to transport fluid for the hydraulic fracturing of the well.

13. The system of claim 11, wherein the above ground pipe includes a surface laid pipe, a lay-flat pipe, a steel pipe, a PVC pipe, a synthetic pipe, and/or a polyethylene pipe.

14. The system of claim 11, wherein the fiber optic cable is laid on the above ground pipe with a sinusoidal curvature.

15. The system of claim 14, wherein the sinusoidal curvature of the fiber optic cable increases contact between the fiber optic cable and the above ground pipe.

16. The system of claim 14, wherein the sinusoidal curvature of the fiber optic cable positions the fiber optic cable between a five o'clock position and a seven o'clock position of the above ground pipe.

17. The system of claim 14, wherein the sinusoidal curvature of the fiber optic cable is stretched and/or squeezed along the above ground pipe.

18. The system of claim 11, wherein the one or more physical processors are further configured by the machine readable-instructions to locate pinch-points along the above ground pipe based on the measurement using the fiber optic cable laid on and temporarily attached to the above ground pipe.

19. The system of claim 18, wherein:
one or more kinks in the above ground pipe are identified at the pinch-points; and
the one or more kinks in the above ground pipe are fixed.

20. The system of claim 11, wherein the one or more physical processors are further configured by the machine readable-instructions to facilitate one or more operations for the above ground pipe based on detection of fluid leaks along the above ground pipe.
